(19) United States
(12) Patent Application Publication
(10) Pub. No.: US 2026/0158383 A1
(43) Pub. Date: Jun. 11, 2026

(54) INFORMATION PROCESSING DEVICE, INFORMATION PROCESSING METHOD, AND PROGRAM

(71) Applicant: Sony Interactive Entertainment Inc., Tokyo (JP)

(72) Inventors: Shogo Sato, Tokyo (JP); Hiroyuki Segawa, Kanagawa (JP); Tetsugo Inada, Tokyo (JP)

(21) Appl. No.: 19/465,041

(22) Filed: Jan. 30, 2026

Related U.S. Application Data
(63) Continuation of application No. PCT/JP2023/028306, filed on Aug. 2, 2023.

(51) Int. Cl. A63F 13/52; A63F 13/79; G06F 3/01; G06V 40/16; G06V 40/20

(52) U.S. Cl. CPC A63F 13/52; A63F 13/79; G06F 3/012; G06F 2203/011; G06V 40/174; G06V 40/20

(57) ABSTRACT

Provided is an information processing device that acquires target content having details that change over time and predetermined time-series information recorded while the target content is being output, acquires model output data corresponding to element data constituting the target content by using a machine learning model obtained by performing machine learning on a relationship between element data included in content and descriptive information that linguistically describes details of the element data, and executes a predetermined process based on the acquired time-series information and the acquired model output data.

### CROSS-REFERENCE TO RELATED APPLICATIONS

This application is a continuation of and claims the benefit of priority to PCT Application No. PCT/JP2023/028306, filed on Aug. 2, 2023, the contents of which are incorporated by reference.

### FIELD

The present specification relates to an information processing device, an information processing method, and a program for analyzing moving images.

### BACKGROUND

When a user plays a video game, an information processing device that executes the program renders moving images with the details that change in accordance with the progress of the game, and presents the moving images to the user. By analyzing the moving images described above, it is possible to obtain information such as what kind of play the user is performing in a particular scene, for example. In this way, it is desirable to analyze various types of details presented to the user in order to obtain useful information.

### SUMMARY

However, since content that a user generally watches is massive in both playback time and data volume, manual analysis is not realistically feasible. Furthermore, when the analysis is mechanically performed by a computer without manual analysis, the information obtained is not necessarily meaningful to humans.

This specification provides an information processing device, an information processing method, and a program capable of effectively analyzing content presented to a user.

An information processing device according to one aspect of the present specification is an information processing device comprising one or more processors, wherein the one or more processors are configured to: acquire target content having details that change over time and predetermined time-series information recorded while the target content is being output; acquire model output data corresponding to element data constituting the target content by using a machine learning model obtained by performing machine learning on a relationship between element data included in content and descriptive information that linguistically describes details of the element data; and execute a predetermined process based on the acquired time-series information and the acquired model output data.

An information processing method according to one aspect of the present specification is an information processing method comprising: acquiring target content having details that change over time and predetermined time-series information recorded while the target content is being output; acquiring model output data corresponding to element data constituting the target content by using a machine learning model obtained by performing machine learning on a relationship between element data included in content and descriptive information that linguistically describes details of the element data; and executing a predetermined process based on the acquired time-series information and the acquired model output data.

A program according to one aspect of the present specification is a program for causing a computer to execute the processes of: acquiring target content having details that change over time and predetermined time-series information recorded while the target content is being output; acquiring model output data corresponding to element data constituting the target content by using a machine learning model obtained by performing machine learning on a relationship between element data included in content and descriptive information that linguistically describes details of the element data; and executing a predetermined process based on the acquired time-series information and the acquired model output data. The program may be provided while being stored in a computer-readable non-transitory information storage medium.

### BRIEF DESCRIPTION OF THE DRAWINGS

FIG. 1 is a block diagram illustrating a configuration of an information processing device according to an implementation.

FIG. 2 is a block diagram illustrating a function of the information processing device according to the implementation.

FIG. 3 is a diagram illustrating an example of a learning process for generating a machine learning model used by the information processing device according to the implementation.

FIG. 4 is a diagram illustrating a relationship between time-series information and model output data corresponding to element data constituting the target content.

### DETAILED DESCRIPTION

Hereinafter, implementations of the present specification will be described in detail with reference to the drawings.

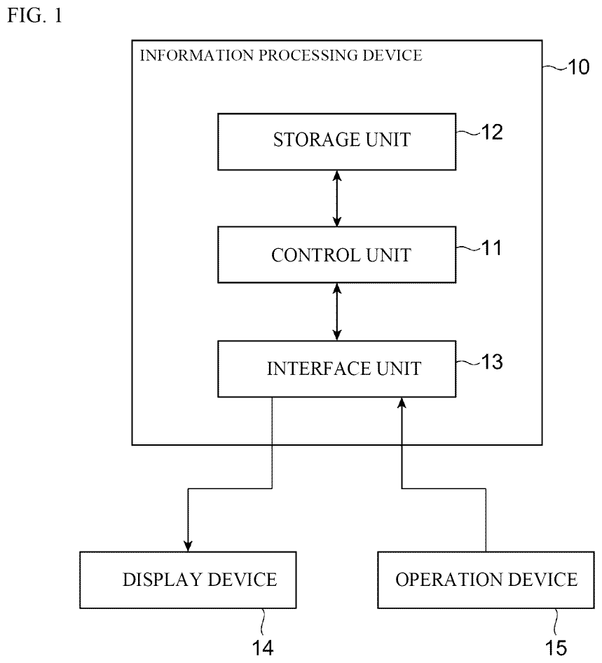

FIG. 1 is a block diagram illustrating a configuration of an information processing device 10 according to one implementation of the present specification. The information processing device 10 is a personal computer, a server computer, or the like, and includes a control unit 11, a storage unit 12, and an interface unit 13 as illustrated in FIG. 1. In addition, the information processing device 10 is connected to a display device 14 and an operation device 15.

The control unit 11 includes at least one processor such as a CPU, and executes programs stored in the storage unit 12 to execute various types of information processes. In the present implementation, specific examples of the processes executed by the control unit 11 will be described later. The storage unit 12 includes at least one memory device such as a RAM, and stores the programs executed by the control unit 11 and data processed by the programs.

The interface unit 13 is an interface for data communication between the display device 14 and the operation device 15. The information processing device 10 is connected to the display device 14 and the operation device 15 via the interface unit 13 in either a wired or wireless manner. Specifically, the interface unit 13 includes a multimedia interface for transmitting a video signal supplied by the information processing device 10 to the display device 14. In addition, the interface unit 13 includes a data communication interface for receiving signals that indicate operation details performed by a user on the operation device 15.

The display device 14 displays a video corresponding to the video signal supplied from the information processing device 10 on a screen. The operation device 15 is, for example, a keyboard or a mouse, and receives an operation input from the user. The operation device 15 is connected to the information processing device 10 in a wired or wireless manner, and transmits an operation signal, which indicates the details of the operation input received from the user to the information processing device 10.

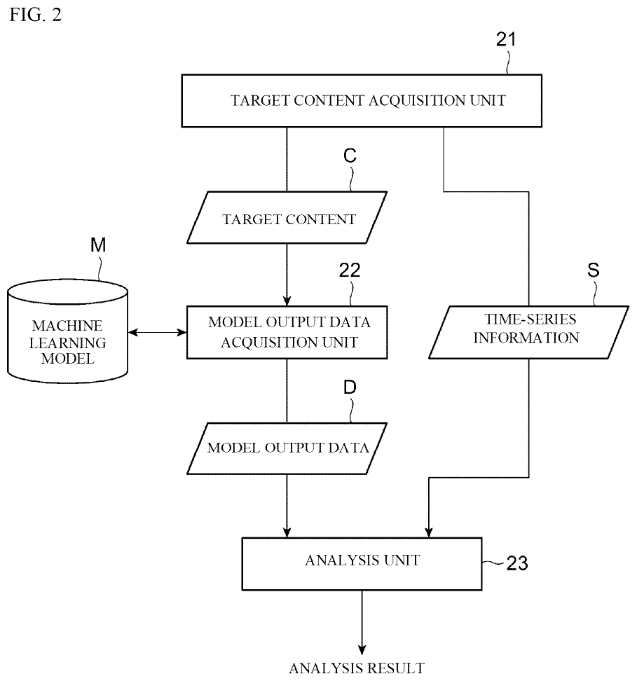

Hereinafter, the functions implemented by the information processing device 10 will be described with reference to the functional block diagram of FIG. 2. As illustrated in FIG. 2, the information processing device 10 functionally includes a target content acquisition unit 21, a model output data acquisition unit 22, and an analysis unit 23. The functions are implemented by the control unit 11 operating in accordance with one or more programs stored in the storage unit 12. The programs may be provided to the information processing device 10 via a communication network such as the Internet, or may be provided while being stored in a computer-readable information storage medium such as an optical disk.

The target content acquisition unit 21 acquires data of the content to be analyzed. Hereinafter, the content to be analyzed by the information processing device 10 according to the present implementation will be referred to as target content C. The target content C is content with details that change over time, and is typically video content including moving images and audio. In the following description, it is assumed that the target content C is content that has actually been played back and presented to the user. In addition, the user is a user U who watches the target content C when the content has been output. However, the target content C is not limited thereto, and may be various types of content that change over time and are output over a certain period of time, for example, content including only moving images or only audio.

As an example, the target content C may be a game video that is rendered by a user terminal and displayed on the display device to present the game video to the user U, when the user U plays a game using the user terminal owned by the user U. In this case, the target content C is a video that changes in real time according to the details of the operation input, which is performed by the user U on the operation device connected to the user terminal.

Furthermore, the target content acquisition unit 21 acquires, together with the target content C, predetermined time-series information S recorded while the target content C is being output and presented to the user U.

As a specific example, the time-series information S may be time-series operation information indicating the details of the operation input performed by the user U, who is watching the target content C, which is a game video, on the operation device while the target content C is being output. The time-series operation information includes information capable of identifying the details of the operation performed by the user U (for example, the button pressed, the operation direction and amount of a stick-type operation member, and the like) and a timing when the operation has been performed.

In addition, the time-series information S is not limited to the time-series operation information, and may be various types of information regarding a situation of the user U while the target content C is being output. For example, the time-series information S may include information obtained by recording, in real time using various sensors, a vital sign (such as heart rate) and a behavior (such as body movement) of the user U who is watching the target content C. In addition, the time-series information S may include information such as a facial expression or eye movement of the user U obtained by capturing images of the user U with a camera. In addition, the target content acquisition unit 21 may acquire, as the time-series information S, information obtained by analyzing the information recorded in real time. For example, by analyzing videos obtained by capturing the images of user U or information regarding physical movements of the user U, the target content acquisition unit 21 may acquire, as the time-series information S, information indicating that user U has left his/her seat at a predetermined timing, information indicating emotions that user U has felt at each time point, information regarding a degree of concentration on the target content C, information indicating a part of the target content C to which the user pays attention, and the like.

By referring to the target content C in combination with the time-series information S, the information processing device 10 can identify the details of the operation performed by the user U at a timing when a certain image is displayed, or a situation of the user U, such as the facial expression, posture, and emotions of the user U at the timing.

The model output data acquisition unit 22 acquires model output data D, which corresponds to each of one or more elements constituting the target content C, using the machine learning model M. The machine learning model M is a machine learning model obtained by learning a relationship between element data included in the content and descriptive information used to linguistically describe the details of the element. Hereinafter, for the sake of convenience, the machine learning model M is assumed to be a model obtained by learning a relationship between various types of image data and descriptive information that linguistically describes the details of the image. However, the present specification is not limited thereto, and the model output data acquisition unit 22 may use a machine learning model M obtained by learning a relationship between an element such as short audio that is played during playback of the target content C and descriptive information that linguistically describes the content of the target content C, as elements constituting the target content C.

The machine learning model M used in the present implementation may be a model based on various techniques as long as it can acquire information used to linguistically describe the details of the elements constituting the target content C. For example, when an analysis target is image data indicating a situation in which a horse carrying a man is running, it is desirable that the machine learning model M not simply output the names and positions of objects (horses, man, and the like) included in the image, but also be a model that can ultimately obtain descriptive sentences such as “A samurai is riding a horse through the wilderness”. The machine learning model M that enables such an output can be generated by a technique such as contrastive language-image pre-training (CLIP).

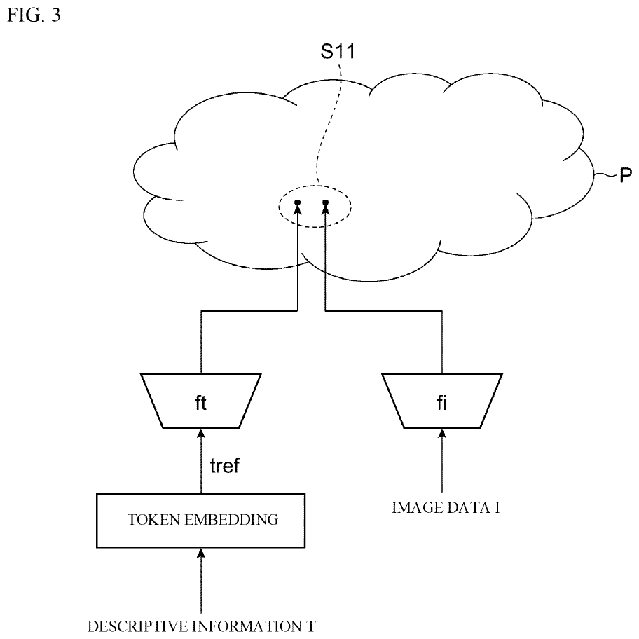

However, in the present implementation, the model output data D, which is acquired by the model output data acquisition unit 22 as the output from the machine learning model M, does not need to be descriptive sentences that can be understood by humans, but may be information that corresponds to linguistic information. Hereinafter, one example of a learning process for generating the machine learning model M used by the information processing device 10 according to the present implementation will be described with reference to FIG. 3.

In the example, a learning processing device that executes the learning process receives a plurality of sets of learning data, in which each set of learning data includes image data and descriptive information that linguistically describes the image data. For each set of learning data, a learning device divides the descriptive information included in the set into tokens (for example, words) t to obtain a distributed representation tref thereof (token embedding). The learning processing device then generates description-related data ft (tref) by encoding the tokens using a text encoder. The description-related data ft (tref) is multidimensional vector data, and corresponds to one of coordinate information within an abstract space.

In addition, the learning processing device generates image-related data fi (I) obtained by inputting image data I included in the same set as the descriptive information T into an image encoder. The learning processing device sets the image encoder such that the image-related data fi (I) is also vector data of the same dimension as the description-related data ft (tref). The image-related data fi (I) also corresponds to one of the coordinate information within the abstract space.

The learning processing device performs machine learning on each encoder ft or fi such that the description-related data ft (tref) and the image-related data fi (I) are positioned close to each other within the above-described predetermined abstract space (a space of the vector dimension of the description-related data or image-related data, and a multimodal embedding space in CLIP). As a result, conceptually, as illustrated in the example of FIG. 3, the image data and the descriptive information describing the image data are associated with each other within a predetermined abstract space P (S11). In the above example, the text encoder ft can use a well-known transformer network, and the image encoder fi can use a vision transformer (ViT).

In the present implementation, the data of the machine learning model M, which is generated by the machine learning, is stored in advance in the storage unit 12. The model output data acquisition unit 22 inputs data of the elements, which constitute the target content C (for example, frame images constituting a moving image of the target content C) acquired by the target content acquisition unit 21, into the machine learning model M, and outputs an output of the data as model output data D.

When the machine learning model M that converts each element into a vector within the above-described abstract space P is used, the model output data D may be the image-related data fi (I) itself obtained by inputting frame image data I constituting the target content C into the image encoder fi. In addition, the model output data D may be data regarding a character string representation obtained by inputting the image-related data fi (I) into the text encoder that converts the tokens corresponding to the descriptive information T into a vector representation and a decoder that performs reverse conversion. The model output data D is data that more directly represents words and sentence expressions related to the frame image data I.

In addition, an index value (such as cosine similarity), which indicates a distance in the abstract space P between the description-related data ft (tref) corresponding to the descriptive information T prepared in advance and the image-related data fi (I), may be calculated, and evaluation results using the index value may be used as the model output data D. By using the index value, it is possible to evaluate the extent to which the frame image data I corresponds to the details indicated by the predetermined descriptive information T. For example, by preparing a plurality of descriptive information T regarding violent expressions in advance and evaluating the extent to which the frame image data I to be analyzed is close to the plurality of descriptive information T within the abstract space P, it is possible to determine whether the frame image data I includes the violent expressions.

Furthermore, the model output data D may be data obtained by performing clustering on the distribution within the abstract space P obtained by converting a plurality of image data into the vector representation. For example, a plurality of image-related data fi (I), which is obtained by inputting a plurality of image data extracted in a predetermined manner into the image encoder fi, is subjected to a clustering process of grouping the plurality of image-related data fi (I) within the abstract space P. As a result, for example, when three clusters are extracted, it can be estimated that the image data belonging to each of the clusters is an image having similar meanings. Furthermore, the descriptive information T corresponding to a position of each cluster may be acquired as the model output data D. The descriptive information T can be used to roughly describe the details of the image data belonging to the corresponding cluster.

In this case, the descriptive information T corresponding to the position of the cluster may be descriptive information T corresponding to a vector that has the shortest distance from a center position of the cluster among vectors obtained by converting a plurality of candidates of the descriptive information T, which serve as references prepared in advance. Alternatively, the descriptive information T corresponding to the center position of the cluster may be obtained using the decoder that performs reverse conversion of the text encoder described above. The decoder can be generated by machine learning, which performs tasks such as converting strings into vectors and restoring the vectors to the original strings on a corpus prepared in advance. In addition, the descriptive information T obtained as a sentence expression may be input again into a predetermined encoder to obtain an embedding, which may be used as the model output data D. The character strings corresponding to the plurality of clusters obtained in this way can be visualized using a technique called a word cloud. When a cluster is extracted from the vector distribution within the abstract space P, the cluster may be extracted from the entire distribution within the abstract space P obtained by inputting image data that is obtained from the entire target content C, and a portion of vectors that satisfy specific conditions may be extracted as a cluster. In any case, the model output data D obtained by inputting certain image data into the machine learning model M is data that can be used to indicate the details of the image data in a way that can be understood by humans. The analysis unit 23, which will be described later, analyzes the details of the target content C using the model output data D.

The machine learning model M described above is merely an example, and in the present implementation, the model output data acquisition unit 22 can use various types of models that can obtain the meaning of an image or descriptive information about the image as the machine learning model M. For example, the model output data acquisition unit 22 may use, as the machine learning model M, a model that has been trained to obtain answers to questions about images by using the images, the questions about the images, and the answers thereof as learning targets. In addition, by inputting sentences or the like that serve as conditioning for the viewpoint of information extraction together with the image, a model that has been trained to extract information about a specific viewpoint may be used as the machine learning model M. By using the machine learning model, the analysis unit 23, which will be described later, can analyze the target content C focusing on the specific viewpoint.

Further, in the explanation so far, the machine learning model M receives the frame image data constituting the target content C as an input, but it is also possible to use the machine learning model M that receives relatively short moving images as an input. Accordingly, it is possible to perform analysis taking into account the movement of objects included in the moving images.

In this case, the image data that serves as a target from which the model output data acquisition unit 22 acquires the model output data D may be data of partial elements selected from among the elements constituting the target content C according to a predetermined criterion. Specifically, for example, the model output data acquisition unit 22 extracts frame images presented to the user at timings such as every second to use the frame images as targets for acquiring the model output data D. Alternatively, the model output data acquisition unit 22 may acquire the model output data D from a frame image displayed at a timing when data satisfying a specific condition appears in the time-series information S (for example, a timing when the user performs a predetermined operation). A specific example of selecting an element based on the details of the time-series information S will be described later.

The analysis unit 23 performs analysis on the target content C by executing a predetermined process based on the time-series information S acquired by the target content acquisition unit 21 together with the target content C and the model output data D acquired by the model output data acquisition unit 22 and corresponding to the element data constituting the target content C. The analysis unit 23 may perform analysis from various viewpoints, but in particular, in the present implementation, by evaluating the time-series information S indicating a situation of the user at a specific timing in relation to model the output data D corresponding to the element data presented to the user at a timing corresponding to the timing, it is possible to obtain analysis results in a form that is easier for humans to understand, regarding an influence from the target content C that is experienced by the user.

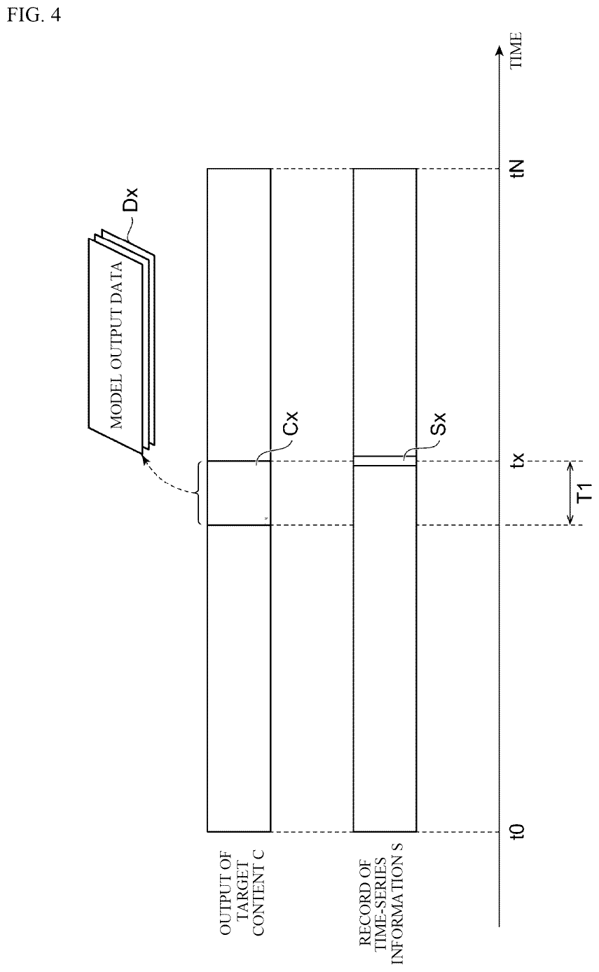

FIG. 4 is a diagram conceptually illustrating an example of an analysis process performed by the analysis unit 23. A horizontal axis of FIG. 4 is a time axis, and indicates that the target content C is presented to a user U during a time period from time to t0 time tN. In addition, in the example illustrated in FIG. 4, the time-series operation information indicating the details of the operation input performed by the user U is acquired for a period from time to t0 time tN. In addition, in the example illustrated in FIG. 4, it is assumed that the user U performs a predetermined operation (press operation of an action button) at time tx, and operation information Sx indicating the details of the operation is recorded. In this case, the analysis unit 23 uses a plurality of model output data Dx, which is obtained from a plurality of frame images constituting content Cx displayed within the period T1 and presented to the user, for a predetermined period T1 up to time tx so as to analyze the details of the content Cx presented to the user during the period T1. The details may be a cause of the operation performed by user U at time tx. Therefore, by combining the time-series operation information at the predetermined timing with the model output data D obtained from the frame image data constituting the target content C presented to user U at a timing corresponding to that timing (here, the period T1 preceding time tx) and using the combination for analysis, the cause of the operation performed by user U can be estimated. Conversely, by performing the analysis using the model output data D on elements presented to the user U in a period after a predetermined time tx, the analysis unit 23 can estimate an influence of the operation performed by the user U on the target content C.

Hereinafter, a plurality of specific examples of the analysis process performed by the analysis unit 23 will be described.

First, as a first example, an example of identifying a cause of a game interruption will be described. In the example, the target content C is a play moving image of a game, the element data is data of frame images constituting the play moving image, and game time-series information S is time-series operation information that indicates the operation details of the user U during game play.

In the example, when the user U performs an operation of interrupting the game while playing the game, the analysis unit 23 identifies a timing when the interruption operation is performed by referring to the time-series operation information. Then, a cause of the user U interrupting the game is inferred by using the details of the model output data D acquired by the model output data acquisition unit 22 based on the image data of the target content C that is output within a predetermined period preceding the timing. Specifically, when the analysis unit 23 reads occurrence of an event that is to be negatively evaluated by the user U immediately before the game is interrupted, the event may be the cause of the game interruption.

More specifically, when the model output data D is information indicating vectors within the abstract space P as described above, the analysis unit 23 may use the cluster distribution within the abstract space P to analyze the cause of the user U interrupting the game. For example, the analysis unit 23 compares the distribution within the abstract space P of vectors obtained based on the details presented at a predetermined time immediately before the user U interrupts the game with the distribution within the abstract space P of vectors obtained from the details presented at other time periods (that is, time periods assumed to be a normal state where the cause of the interruption does not occur). In addition, when a cluster to which more vectors belong is found compared to the normal state, the descriptive information corresponding to that cluster may indicate the cause of the interruption. When the cluster indicating the cause of interruption is extracted, it may be estimated whether there is a possibility that a negative event that causes the interruption is intended by an evaluation process based on a natural language model, and the like, and the cluster that has the possibility of indicating the negative event may be extracted as a determination target. If the number of vectors belonging to the cluster extracted in this way increases compared to the normal state, it is estimated that the descriptive information corresponding to the cluster is the cause of the interruption.

As a second example, an example of identifying the cause when the user U repeatedly performs the same operation will be described. In the second example, as in the first example, a play moving image and time-series operation information obtained when the user U plays the game are analyzed.

When the user U repeatedly performs the same operation in a short period of time while playing a game, the operation may be a normal operation necessary for the game to progress, but the operation may also be an operation performed because there is a problem in the progress of the game, such as the game being unable to progress. Therefore, the analysis unit 23 refers to the model output data D corresponding to the repeating operation to estimate a cause of the repeating operation.

Specifically, the analysis unit 23 refers to the time-series operation information to detect an operation history in which the same operation is repeated a predetermined number of times or more within a predetermined time. When the operation history is detected, model output data D corresponding to the image data of the target content C presented to the user U during a period in which the operation history has been detected and/or a predetermined period before and after the period, is acquired. The analysis unit 23 analyzes the model output data D to infer the cause of the repeating operation. For example, when the user U repeatedly presses an operation button more than necessary, if it can be identified that the user is in an unfavorable situation during a battle with an enemy in scenes before and after the operation, it can be estimated that the cause of the operation is an attempt to overcome the unfavorable situation. Such estimation can be efficiently achieved not only by simply identifying characters that appear in the image data, but also by estimating the meaning of the image from the model output data acquisition unit 22 and combining the same with time-series operation information.

The analysis unit 23 is not limited to the first and second examples described so far, and by extracting an operation that satisfies a specific condition from the time-series operation information and using the model output data D corresponding to an element presented to the user U at a timing determined according to the timing when the operation has been performed, the analysis unit 23 can identify the details of the target content C, which is the cause of the operation, the details of the target content C caused by the operation, or the like.

As a third example, an example of estimating an emotion of the user U based on the time-series information S and analyzing a relationship between the emotion of the user U and the target content C will be described.

There are methods for estimating the emotion of the user U at any given time by using various types of time-series information S. For example, by capturing an image of a facial expression of the user U who is watching the target content C using a camera to acquire a resulting video as the time-series information S, it is possible to estimate the emotion of the user U from a change in the facial expression. In addition, by acquiring data obtained by measuring in real time vital information of the user U, such as heart rate, as the time-series information S, it is possible to identify whether the user U is in a state of tension or excitement. In addition, the time-series operation information can be used to estimate the emotion of the user. For example, when an operation such as repeatedly pressing a button within a short period of time is performed, it can be estimated that the user U may be excited.

When it is estimated that the user U is experiencing a specific emotion based on the time-series information S, the analysis unit 23 acquires model output data D indicating the details of the target content C presented to the user U during a period determined according to the timing (a period when the user U is experiencing a specific emotion, and/or a predetermined period before or after the period). By analyzing the model output data D, the analysis unit 23 can identify information that is meaningful to humans, such as an event that causes the user U to feel the specific emotion, a behavior taken by the user U who feels the specific emotion, or the like.

Furthermore, the information regarding the emotion of the user U obtained in this manner can also be used to estimate the cause of the interruption in the first example described above. For example, the analysis unit 23 identifies a change over time in the emotion of the user U, thereby identifying a timing when the user U has a negative emotion in a time period before the user U interrupts the game. Then, the model output data D indicating the details of the target content C presented to the user U at the timing is acquired. Accordingly, the analysis unit 23 can analyze a cause of the interruption of the game by the user U at a finer level of granularity.

Furthermore, in the above explanation, a time-series change in the emotion of the user U is identified, and the analysis is performed by linking the emotion with the model output data D based on the details of the target content C. However, the present specification is not limited thereto, and the analysis unit 23 may identify various situations of the user U who is watching the target content C, and may execute the analysis process using the details of the situations and the details of the target content C as the evaluation targets. For example, by acquiring, as the time-series information S, output results of a sensor, which is built into an operation device held by user U who is watching the target content C, the analysis unit 23 can identify a timing when the user U throws the operation device or a timing when the user U puts down the operation device. In addition, by acquiring video data from the camera capturing an image of the state of user U as the time-series information S, the analysis unit 23 can identify a timing when the user U is looking away or a timing when the user U is away from his/her seat (that is, when the target content C is being played back, but user U is not watching the target content C). The analysis unit 23 can estimate the cause of the behavior taken by the user U by referring to the model output data D indicating the details of the target content C at a timing corresponding to an attention timing identified based on the time-series information S.

As a fourth example, an example of identifying the details of the target content C that the user U pays attention to will be described. In the example, the target content acquisition unit 21 acquires, as the time-series information S, information regarding an attention pattern of the user U to the target content C. In this case, the information regarding the attention pattern may include information about an attention position (information indicating which position the user U is paying attention to in the screen on which the target content C is presented), or information about an attention level (information indicating how much the user U is paying attention to the target content C, that is, how intensely the user is concentrating on watching the target content C).

The information regarding the attention pattern can be obtained by capturing an image of a face of the user U to identify a facial direction or a gaze of the user U. Specifically, a technology for identifying a gaze direction based on a position of pupils of the user U is known. In addition, it is possible to estimate a degree to which the user U is concentrating on the target content C based on information such as eye movement.

The analysis unit 23 can identify the details of the target content C presented at a timing when the user U is estimated to exhibit a high (or low) degree of attention by referring to the information regarding attention patterns obtained in this manner and the model output data D. Accordingly, it is possible to analyze what kind of details attract the interest of the user U, and at what timing the details being presented causes the user U to become bored.

Further, when the attention position of the user U can be identified, the details displayed in an area to which the user U pays attention may be identified. As a specific example, the analysis unit 23 extracts a partial image based on a position to which the user U particularly pays attention from among the frame image data constituting the target content C. Then, the model output data D, which is output by the model output data acquisition unit 22 using the partial image as an input, is acquired as information indicating the details to which the user U pays attention. By executing such a process, it is possible to identify what object in the frame images constituting the target content C particularly attracts interest of the user U.

As a fifth example, an example of generating summary information of the target content C will be described. By using the model output data D, the analysis unit 23 can generate a summary of the target content C. Specifically, for example, the analysis unit 23 can identify a general flow of the details of the target content C along a time series by extracting the model output data D corresponding to the image data presented to the user at regular intervals. More specifically, the analysis unit 23 may generate a summary that describes the overall details by inputting a plurality of model output data D obtained at regular intervals into another machine learning model (for example, a model that generates natural language, such as a large-scale language model).

In addition, the analysis unit 23 may search for the presence or absence of image data matching a predetermined linguistic expression, thereby identifying whether a certain event has occurred or whether a certain object has appeared within the target content C, and may record the same as the summary information. In this case, the recorded summary information may be linguistic descriptive information or embedded data. The summary information can be used for purposes such as searching for content that includes a specific scene from among a large number of target contents C. In particular, by recording the summary information using the model output data D, the user can search for a scene he/she wants to see using natural language expressions such as, for example, “Find a scene where someone is attacked by zombies and escapes by breaking a window”.

When the summary information is generated, the analysis unit 23 can use the time-series information S. For example, the analysis unit 23 uses the time-series information S to identify a timing when the user frequently performs the operation input or a timing when the emotion of the user changes. Then, the model output data D indicating the details of the target content C corresponding to the timing is acquired, and the summary information is generated using the acquired model output data D. In this way, the summary information including the details, which is considered to be particularly important to the user U, can be generated.

As a sixth example, an example of generating statistical information of the target content C will be described. By using the model output data D obtained from the element data constituting the target content C, the analysis unit 23 can generate statistical information by counting the number of times a specific event has occurred within the target content C.

The counting can be implemented to some extent simply by referring to the model output data D acquired over the entire playback period of the target content C. However, the analysis unit 23 can improve the accuracy of the results obtained and make the processing more efficient by combining and using the time-series information S.

For example, when counting the number of times a user character operated by user U in a game performs a specific action, the analysis unit 23 acquires the corresponding model output data D based on image data displayed at a timing corresponding to a timing when the user performs an operation that produces the action. Accordingly, it is possible to count the number of shots taken by the user character and the number of passes made in a soccer game, for example. In particular, the analysis unit 23 can efficiently measure the number of times an action is performed by referring to the time-series operation information and determining whether the action is actually performed using the model output data D at a timing when the user U performs the operation that produces an action to be counted. In addition, provided that a condition of the time-series operation information indicating the user U performing a predetermined operation exists, the analysis unit 23 extracts model output data D indicating that the action has been performed, so that an action performed by the user character may be identified from an action performed by another character and the counting may be performed only for actions resulting from operations of the user character.

The summary information or statistical information described above can also be used to add various types of metadata to the target content C or to perform more general-purpose data analysis. As a specific example, by referring to the statistical information obtained from the plurality of target contents C, it is possible to count the overall number of times a specific action has been performed, or to determine the percentage of play data that produces a specific event.

In addition, the analysis unit 23 can use techniques similar to those used to obtain the summary information or the statistical information as described above to perform a qualitative evaluation for the details of game play of the user U, rather than being limited to a conventional quantitative evaluation. For example, the analysis unit 23 can evaluate the skill and proficiency of the play of the user U, which cannot be evaluated simply by the statistical information such as the number of wins or hits by extracting model output data D that indicates whether the enemy is attacked from a blind spot or whether a decoy is used to catch the enemy off guard. The evaluation results can be used for evaluation of rating of the user U or for matching users with each other.

In addition, the information can be used to analyze a play style of the user U. For example, in a cooperative game, when the user character operated by user U acts at a position away from companion characters of other users, it may be estimated that user U is an uncooperative player simply from information about an average distance between the characters in the conventional case. However, if the summary information can identify that the user character usually keeps the distance from the companion characters but takes action to help the companion characters when the companion characters are in trouble, it can be assumed that the user U is a cooperative player. In addition, by obtaining model output data D indicating a behavior of the user character, it is possible to evaluate whether the play style is aggressive (or passive), whether the play style is one that progresses through the game quickly to achieve results, or whether the play style is one that progresses slowly.

In the explanation so far, since the main example is target content C with the details that change according to the operation input of the user U, such as game play moving images, it is assumed that there is only one user U watching one target content C, and that the target content acquisition unit 21 acquires time-series information S regarding that user U. However, the target content C to be analyzed by the information processing device 10 according to present implementation is not limited to content that has been watched by only one user U.

For example, the target content C may be content, such as a video distributed via a communication network such as the Internet or a game in which a plurality of people participate via the communication network. In this case, a plurality of users U watch the target content C simultaneously or at different times. In such an example, the target content acquisition unit 21 acquires time-series information S indicating the details of the operation, the vital information, or the like for each of the plurality of users U, and the analysis unit 23 may analyze the target content C based on the plurality of acquired time-series information S.

Furthermore, the time-series information S may be statistical information regarding the plurality of users U who simultaneously watch the target content C. Such an example will be described later as a seventh example.

In the example, the target content C is content that is distributed simultaneously via a communication network, such as live video. The target content acquisition unit 21 acquires, as the time-series information S, viewer number information indicating how the number of viewers of the target content C has changed in real time, when the target content C is distributed.

The analysis unit 23 refers to the viewer number information as the time-series information S to identify a portion of the target content C that has been particularly watched (a period with a large number of viewers), or conversely, a portion that has not been watched (a period with a small number of viewers). In addition, a timing when the number of viewers is changed significantly, such as when the number of viewers is increased or decreased, may be identified. In this way, by acquiring model output data D indicating the details of the content presented to the viewer at a timing corresponding to the identified timing, the analysis unit 23 can estimate causes of what kind of content attracts attention, or what kind of content causes the viewer to stop watching and leave.

In the description so far, the target content C has been described as content that the user U has actually watched or played, but the target content C may also be content generated using an automatic execution program or the like. For example, in order to check the operation of a verification target program, such as a game program, the automatic execution program may automatically execute the verification target program by simulating the same operation inputs as a case where the verification target program is operated by a person. When the automatic execution is performed, it is necessary to check whether the verification target program operates normally, but it is extremely time-consuming for a person to visually check the operation. In addition, when a computer is to automatically determine whether results of the automatic execution are successful, different measures are required for each verification target program, such as accurately defining the determination criteria, so that it is still difficult to execute the process efficiently. Therefore, the information processing device 10 according to the present implementation may use the video, which is output as the result of the automatic execution using the automatic execution program, as the target content C, and may execute the analysis program to estimate whether the program operates normally. Such an example will be described later as an eighth example.

For example, the analysis unit 23 generates the summary information and the statistical information for the target content C that is the result of the automatic execution, as in the fifth and sixth examples described above, and verifies whether the result conforms to the details intended for the automatic execution. In this case, even if the verification itself is performed by humans, checking whether the intended play result is output by referring to the summary information, or the like, can be easily executed compared to visually checking the target content C itself. In addition, if keywords relating to play results are defined in advance, the analysis unit 23 can verify whether the result has been obtained by referring to the summary information or the like. As a specific example, when the game play is automatically executed to achieve an objective such as obtaining a predetermined item or defeating a predetermined enemy in a quest-execution type game, if the model output data D obtained from the target content C includes descriptive information indicating the details corresponding to the objective, it can be determined that the play to achieve the objective is performed normally. Furthermore, if the accuracy of semantic analysis included in the content can be improved, the analysis unit 23 itself can perform analysis based on images of scenes in which a character is given a task in the game to identify the objective to be achieved by a player, and then evaluate the success or failure of the automatic execution by analyzing whether the player is performing actions that are appropriate to the identified objective based on images of subsequent scenes or time-series operation information that indicates the details of the operation input, which is input using the automatic execution program.

As described above, according to the information processing device 10 according to the present implementation, the time-series information S and the model output data D obtained from the element data constituting the target content C are used, so that it is possible to effectively implement analysis that is more meaningful to humans.

The implementations of the present specification are not limited to those described above. For example, in the above description, the data of the frame images constituting moving images is mainly used as the element data constituting the target content C, but the present specification is not limited thereto, and the machine learning model M may include a machine learning model obtained by learning a relationship between audio data and descriptive information that linguistically describes the details of the audio, or a machine learning model obtained by receiving the time-series information itself as a learning target to learn a relationship between the time-series information and the image data, and the like. In any case, by using the model output data D that is output by the machine learning model M obtained by learning the relationship between the elements constituting the content that changes over time and the descriptive information that linguistically describes that details thereof, the information processing device 10 according to the present implementation can implement the analysis process that allows the content of the target content C to be understood in a form that is more meaningful to a human.

In addition, in the above description, the information processing device 10 according to the implementation of the present specification itself stores the machine learning model M, and the model output data D is acquired by inputting element data into the machine learning model M, but this is merely one example. The information processing device 10 may acquire the model output data D by using the machine learning model M held by another computer connected via a communication network, for example.

### REFERENCE SIGNS LIST

10 information processing device, 11 control unit, 12 storage unit, 13 interface unit, 14 display device, 15 operation device, 21 target content acquisition unit, 22 model output data acquisition unit, 23 analysis unit.

What is claimed is:

1. An information processing device comprising:
one or more computer processors; and
one or more non-transitory computer-readable media that store instructions which, when executed by the one or more computer processors, cause the one or more computer processors to perform operations comprising:
obtaining (i) target content having details that change over time, and (ii) predetermined time-series information that was generated while the target content was previously output;
providing particular element data that is associated with the target content to a machine learning model that is trained to the output descriptive information associated with input element data;
obtaining particular descriptive information that the machine learning model outputs for the particular element data that is associated with the target content; and
executing a predetermined process based on the acquired time-series information and obtained predetermined time-series information that was generated while the target content was previously output.

2. The device of claim 1, wherein:
the target content comprises content that was presented to a user, and
the predetermined time-series information comprises information indicating a situation of the user when the user was consuming the target content.

3. The device of claim 2, wherein the operations comprise generating, as the time-series information, information including a facial expression of the user who was consuming the target content, a behavior of the user, or vital information of the user.

4. The device of claim 2, wherein the target content includes a video image that changes according to operation inputs that are performed by the user.

5. The device of claim 4, wherein the operations comprise:
generating, as the time-series information, information indicating details of the operation input that were performed by the user while the user was consuming the target content.

6. The device of claim 4, wherein the predetermined operation comprises an interruption operation for interrupting an output of the target content.

7. The device of claim 6, wherein the operations comprise:
executing, as the predetermined process, a process of determining a cause of the interruption operation.

8. The device of claim 7, wherein the predetermined operation comprises a repeating operation for repeating a same operation a predetermined number of times.

9. The device of claim 8, wherein the operations comprise executing, as the predetermined process, a process of determining a cause of the repeating operation.

10. The device of claim 2, wherein the operations comprise:
determining a time-series change in an emotion of the user who was consuming the target content based on the situation of the user indicated by the time-series information, and
executing the predetermined process based on the determined time-series change.

11. The device of claim 2, wherein the operations comprise:
obtaining, as the time-series information, information regarding an attention pattern of the user to the target content.

12. The device of claim 11, wherein the operations comprising:
executing, as the predetermined process, a process of identifying, based on the attention pattern of the user, details of the target content to which the user pays attention.

13. The device of claim 1, wherein the target content is content presented to a plurality of users.

14. The device of claim 13, wherein the operations comprise:
obtaining, as the time-series information, information indicating a change over time in the number of users that were presented the target content;
identifying a time point to be verified, based on the information indicating the change over time in the number of users.

15. The device of claim 1, wherein the operations comprise:
executing, as the predetermined process, a process of generating statistical information by counting the number of times events to be aggregated have occurred.

16. The device of claim 15, wherein the operations comprise:
determining a number of times the events to be aggregated have occurred at a timing identified based on the time-series information.

17. The device of claim 1, wherein the target content is a video obtained by automatically executing a verification target program using an automatic execution program.

18. The device of claim 17, wherein the operations comprise:
executing, as the predetermined process, a process of evaluating a result of the automatic execution program performing the automatic execution.

19. A computer-implemented method comprising:
obtaining (i) target content having details that change over time, and (ii) predetermined time-series information that was generated while the target content was previously output;
providing particular element data that is associated with the target content to a machine learning model that is trained to the output descriptive information associated with input element data;
obtaining particular descriptive information that the machine learning model outputs for the particular element data that is associated with the target content; and
executing a predetermined process based on the acquired time-series information and obtained predetermined time-series information that was generated while the target content was previously output.

20. One or more non-transitory computer-readable media that store instructions which, when executed by one or more computer processors, cause the one or more computer processors to perform operations comprising:
obtaining (i) target content having details that change over time, and (ii) predetermined time-series information that was generated while the target content was previously output;
providing particular element data that is associated with the target content to a machine learning model that is trained to the output descriptive information associated with input element data;
obtaining particular descriptive information that the machine learning model outputs for the particular element data that is associated with the target content; and
executing a predetermined process based on the acquired time-series information and obtained predetermined time-series information that was generated while the target content was previously output.
